(19) United States
(12) Patent Application Publication
(10) Pub. No.: US 2013/0166041 A1
(43) Pub. Date: Jun. 27, 2013

(54) PLANT MONITORING CONTROLLER

(71) Applicant: Hitachi, Ltd., Tokyo (JP)

(72) Inventors: Takao NISHI, Hitachinaka-shi (JP); Hiroshi SUZUKI, Mito-shi (JP)

(73) Assignee: HITACHI, LTD., Tokyo (JP)

(21) Appl. No.: 13/722,141

(22) Filed: Dec. 20, 2012

(30) Foreign Application Priority Data
Dec. 21, 2011 (JP) 2011-279261

(51) Int. Cl. G05B 15/02

(52) U.S. Cl. CPC G05B 15/02
USPC 700/9

(57) ABSTRACT

A plant monitoring controller, provided with a monitor, that obtains process information from a plant and provides an operation signal to the plant, comprising: a process information database in which process information about the plant is recorded and accumulated; an operation video information database in which operation video information, which is video information displayed on a screen on the monitor, is recorded and accumulated as history information; and a history information database in which manipulation histories of the manipulable devices displayed on a screen on the monitor are accumulated as manipulation history information; wherein the process information, the operation video information, and the manipulation history information are recorded along with time information; and an operation video screen is provided as a screen displayed on the monitor, the operation video screen displaying a change from previous operation video information, read from the operation video information database, along with the time information.

### CLAIM OF PRIORITY

The present application claims priority from Japanese patent application serial No. 2011-279261, filed on Dec. 21, 2011, the content of which is hereby incorporated by reference into this application.

### BACKGROUND OF THE INVENTION

1. Technical Field

The present invention relates to a plant monitoring controller, and more particularly to a plant monitoring controller that uses plant history data.

2. Background Art

Conventionally, if an abnormality occurs in a plant, an observer takes action by making a decision from currently displayed information as well as previously displayed alarms and other information displayed on a monitor as results. Accordingly, it has been sometimes very difficult to identify the cause of the abnormality because, for example, know-how of skilled persons is required or an accurate cause cannot be identified.

Regarding this, since the capacities of storage media have been largely increased and data has been transmitted and received at higher speed in recent years, the idea has been spread that by storing histories of plant states, the stored histories can be used to find the cause of an abnormality or display a screen or message specified in advance for current plant operation.

To implement this idea, a plant monitoring controller is required that can store process information that has been changed due to manipulations by an observer or answerbacks from the plant in a database along with time information and can reproduce a plant state at a desired time by using a reproduction function called “playback”. Another plant monitoring controller is also required that has a “guidance function” that gives a display according to the importance of a process failure in the plant or its sign.

As for these points, if an abnormality occurs in a plant, it is possible in the Patent Literature 1 to clarify changes in the states of units and a process that led to the abnormality by a playback function that stores values of process information about the states of the units as history data and reproduces a previous state.

Thus, a plant state at the occurrence of an abnormality can be more clearly obtained than in a previous investigation method, enabling the cause of the abnormality to be easily identified.

Patent Literature 1: Japanese Patent No. 3602482

### SUMMARY OF THE INVENTION

In the method described above, however, in which only values of process information about the plant are stored in a database as histories and the stored values are used to investigate the cause of an abnormality, sufficient action cannot be taken to identify the cause of an abnormality in cases described below.

A first case is that an abnormality occurred but an accident was avoided because a skilled observer made an operation before an accident occurs. Since no accident has occurred, this situation is not analyzed.

A second case is that process information that does not change leads to a direct cause. An example is a mistaken manipulation caused by an observer. Although the process information can be thought to change due to the mistaken manipulation, it is not possible in the above method to find the reason why the process information has changed.

A third case is that the cause of an abnormality can be displayed only in a predetermined format. In many existing known examples in which a guidance is displayed for the current plant operation on the basis of history data, the display function can only display a predetermined guidance that has been input in advance. Accordingly, it is not possible to display a guidance that is more directly represented for a particular situation at present.

A fourth case is that although process information can be restored, a screen has to be selected that is viewed to identify the cause of an abnormality from the restored process information; after all, whether the cause of the abnormality can be identified may depend on the experience of the investigator.

Accordingly, an object of the present invention is to provide a plant monitoring controller that is improved in the identification of the cause of an abnormality.

To addresses the problems described above, a plant monitoring controller of the present invention, provided with a monitor, that obtains process information from a plant and provides an operation signal to the plant, characterized in that; the plant monitoring controller comprising: a process information database in which process information about the plant is recorded and accumulated; an operation video information database in which operation video information, which is video information displayed on a screen on the monitor, is recorded and accumulated as history information; and a history information database in which manipulation histories of the manipulable devices displayed on a screen on the monitor are accumulated as manipulation history information; and a history information database in which manipulation histories of the manipulable devices displayed on a screen on the monitor are accumulated as manipulation history information; wherein manipulable devices are displayed by being distinguished with each other on a screen given on the monitor; the process information, the operation video information, and the manipulation history information are recorded along with time information; and an operation video screen is provided as a screen displayed on the monitor, the operation video screen displaying a change from previous operation video information, read from the operation video information database, along with the time information.

A manipulation state of a manipulable device on the screen displayed on the monitor may be compared with previous manipulation histories recorded in the history information database, and if there is a matching manipulation history and the matching manipulation history indicates that a problem caused in the past, the operation video screen may be called and displayed.

In correspondence to the previous operation video screen which was called and displayed to indicate information at a previous time, information about the previous time may be displayed.

The operation video screen may include a video display area, a video manipulation area, a time scroll bar, and a date and time selection area, and a change between observer manipulation screens in a specified period may be displayed.

According to the present invention, a mistaken manipulation caused by an observer can also be found by using an operation video function rather than from changes in process information. A screen at the time of the occurrence of an abnormality can be displayed without alteration, so the cause of the abnormality can be investigated without know-how of an investigator. An auto operation guidance function prevents the recurrence of the accident and avoids the accident in advance.

### BRIEF DESCRIPTION OF THE DRAWINGS

FIG. 1 illustrates the structure of a plant monitoring controller according to an embodiment of the present invention.

FIG. 2 illustrates an example of process information stored in a process information database DB1.

FIG. 3 illustrates an example of operation video information recorded in an operation video information database DB2.

FIG. 4 illustrates an example of history information recorded in a history information database DB3.

FIG. 5 illustrates an example of a display given on a screen 90 on a monitor M, on which operation video information is handled.

FIG. 6 illustrates each computers CPU that function to create databases.

FIG. 7 illustrates processing to store process information S2 in the process information database DB1.

FIG. 8 illustrates processing to store operation video information OV in the operation video information database DB2.

FIG. 9 illustrates processing to store history information in the history information database DB3.

FIG. 10 illustrates functions executed by a human-machine device 7 and an operation assisting computer CPU3 to implement an auto guidance message function.

FIG. 11 illustrates an example of a monitor screen on which an auto guidance message is displayed.

FIG. 12 illustrates a specific example of an auto guidance message window W3.

FIG. 13 illustrates a specific example of a mistaken manipulation setting window W4.

FIG. 14 illustrates functions executed by the human-machine device 7 and operation assisting computer CPU3 to implement a mistaken manipulation setting processing function.

FIG. 15 illustrates a specific example of a mistaken manipulation setting window W4, which is displayed after a series of mistaken manipulation setting processing has been completed.

FIG. 16 illustrates the position of the present invention in an entire flow in a normal operation, at the occurrence of a trip, and in the clarification of the cause of the trip.

### DETAILED DESCRIPTION OF THE INVENTION

An embodiment of plant monitoring controller in the present invention will be described below with reference to the drawings.

### Embodiment

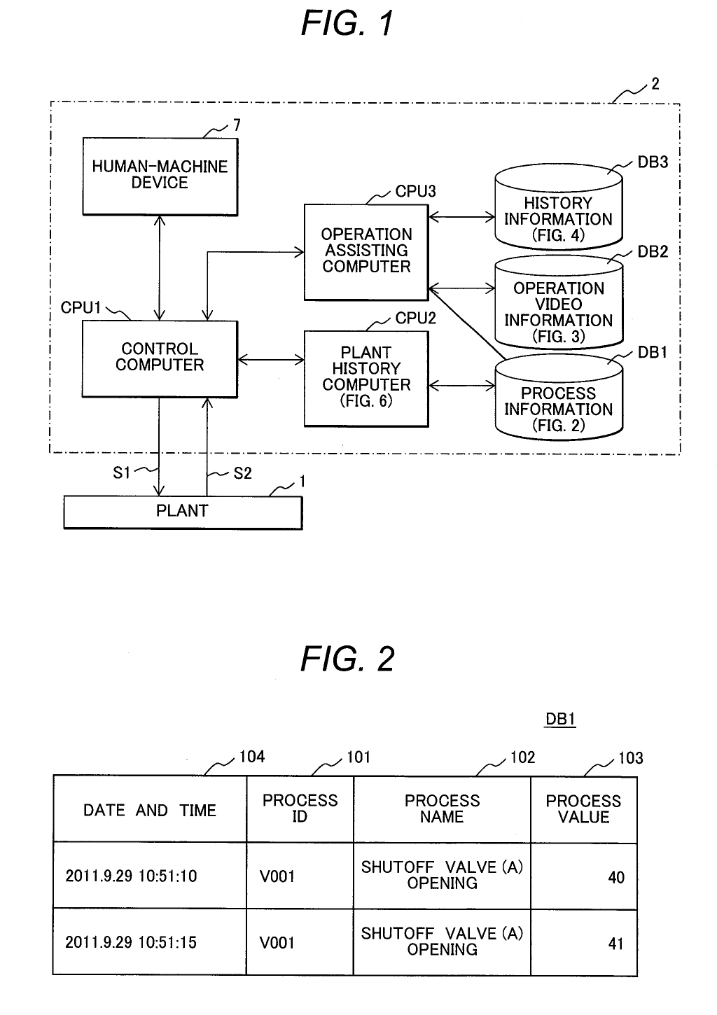

FIG. 1 illustrates the structure of a plant monitoring controller according to an embodiment of the present invention.

The plant monitoring controller 2 in FIG. 1 includes a control computer CPU1 that obtains a process signal S2 from a plant (or plant unit) 1 and sends a control signal S1 to the plant 1 and also has a human-machine device 7, which displays, for example, the operation state of the plant 1 on a monitor and gives various settings, manipulation commands, and the like.

The plant monitoring controller 2 also includes three types of databases DB in which various types of data used in analysis and investigation of a cause is stored. A first database is a process information database DB1 in which the state of the plant 1 is stored as process information. The process information database DB1 is managed by a plant history computer CPU2.

A second database is an operation video information database DB2 in which video information about a monitor screen itself (the video information will be referred to below as operation video information) is stored as history information. The third database is a history information database DB3 in which manipulation histories of the plant 1 are accumulated as history information. The operation video information database DB2 and history information database DB3 are managed by an operation assisting computer CPU3.

The human-machine device 7 accesses the operation assisting computer CPU3 and plant history computer CPU2 through the control computer CPU1. When the operation assisting computer CPU3 is accessed, it accesses the operation video information database DB2 and obtains the operation video information. The operation assisting computer CPU3 also accesses the history information database DB3 and compares the current manipulation with previous manipulation histories.

The plant history computer CPU2 accesses the process information database DB1 and obtains the process history information of the plant 1. Information obtained from the databases DB described above is used to display a screen on a monitor (not illustrated) of the human-machine device 7. A keyboard, mouse, and other manipulation devices (not illustrated) of the human-machine device 7 are operated to give prescribed commands to each computer CPU.

FIGS. 2 to 4 each illustrate an example of specific contents of the relevant database DB. In the process information database DB1 in FIG. 2, for a process ID (101), which is defined as V001, and a process name (102), which is defined as “shutoff valve (A) opening”, process values (103) are recorded sequentially along with date and time information (104), as process information. Similar recording is also performed for other information in the plant 1.

The example of recording in FIG. 2 indicates that the value of “shutoff valve (A) opening” was 40 (%) at 10:51:10 on Sep. 29, 2011 but the value was changed to 41 (%) at 10:51:15. This recording is preferably performed only when a change occurred in the process information, as described later.

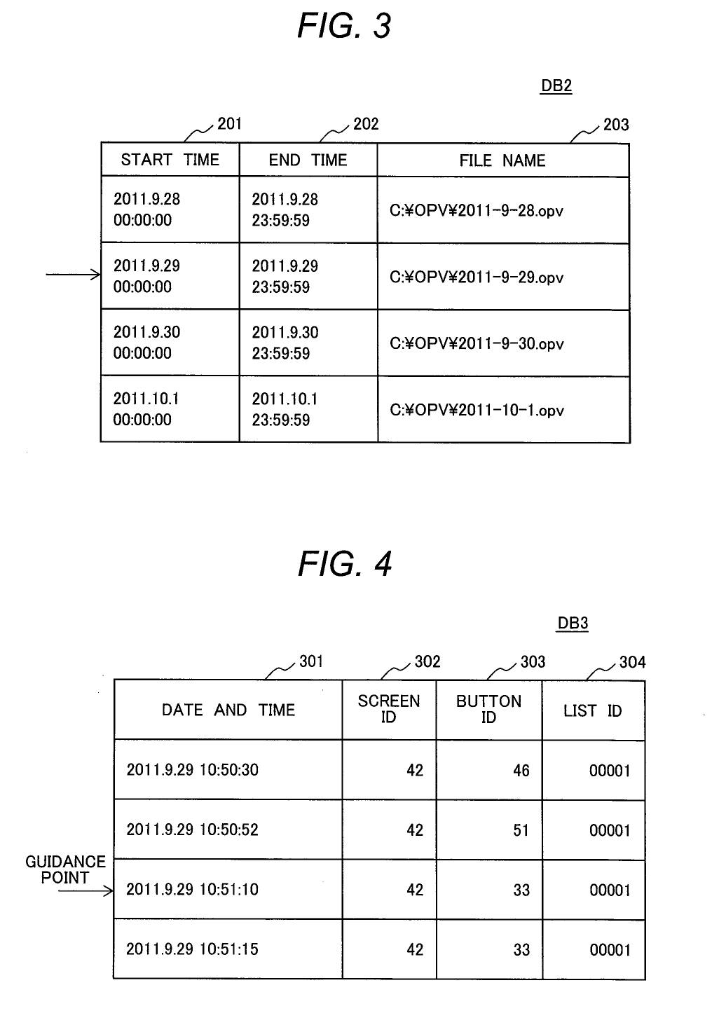

In the operation video information database DB2 in FIG. 3, the file names (203) of files in which operation videos including video information about the monitor screen itself are stored are recorded along with time information from a start time (201) to an end time (202), as process information. In the example in FIG. 3, a file is created on a daily basis. Since a plurality of monitors are usually mounted, operation video information is created for each monitor and stored in an appropriate unit.

Since the operation video information is recorded, the video information about the monitor screen itself of the human-machine device 7 is recorded in time series. Since the operation video information is recorded along with the time information, changes between the monitor screens can be visually identified with reference to the time information during analysis and investigation of a cause on a later day.

In the example in FIG. 3, operation video information on Sep. 28, 2011 is stored in a storage area in drive C under file name “C:¥OPV¥2011-9-28.opv”, and operation video information on Sep. 29, 2011 is stored in a storage area in drive C under a file name “C:¥OPV¥2011-9-29.opv”.

FIG. 4 illustrates an example of history information recorded in the history information database DB3. The history information is records of manipulations performed by an observer while the observer was viewing the monitor of the human-machine device 7. A screen ID (302) that identifies a screen under observation, a button ID (303) of a button manipulated on the screen, and a list ID (304) that indicates a recording place are recorded along with date and time information (301). The record at the top in FIG. 4 indicates that the fact that the observer manipulated a button 46 on a screen indentified by a screen ID of 42 at 10:50:30 on Sep. 29, 2011 was stored in a list 00001. Accordingly, the history information is information created by the observer.

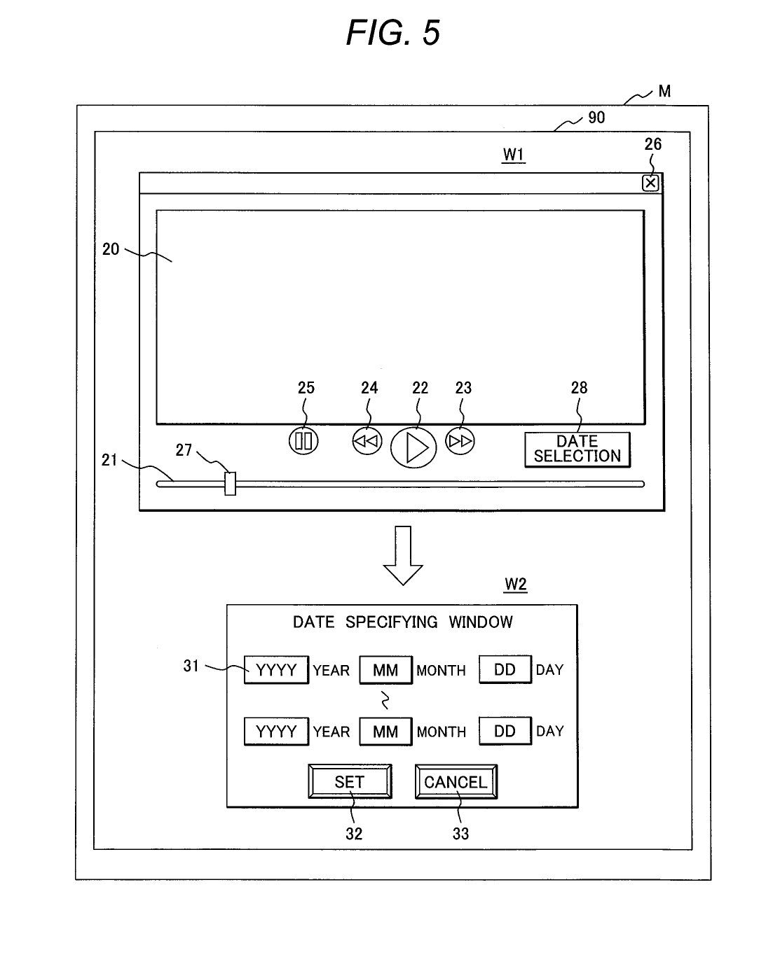

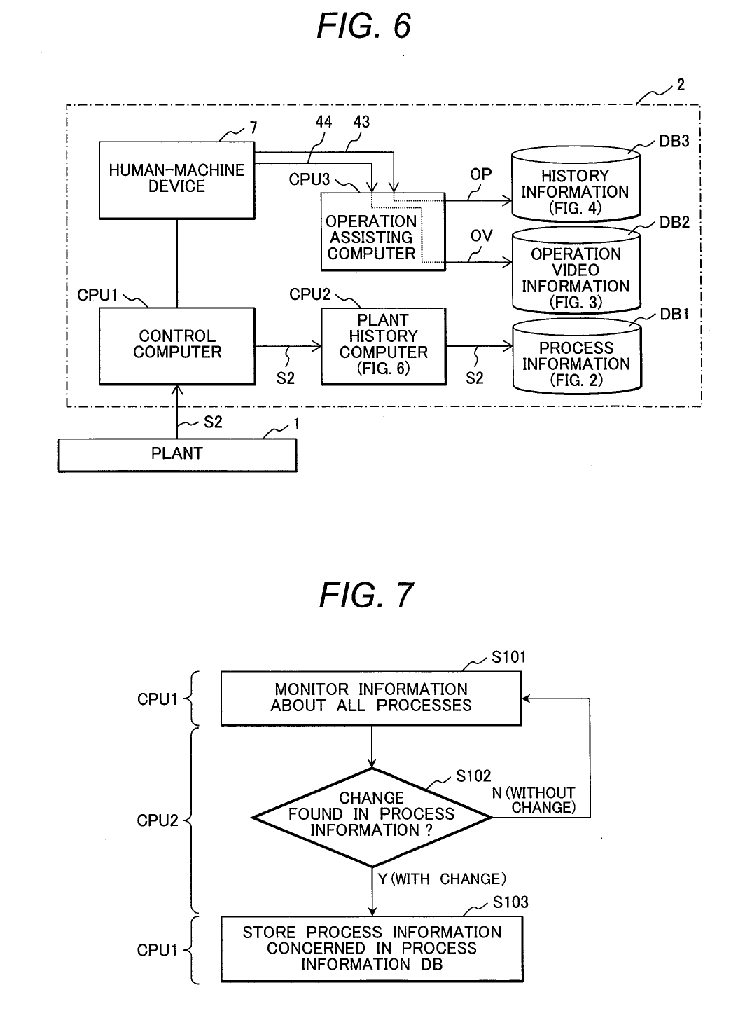

FIG. 5 illustrates an example of a display given on a screen 90 on a monitor M, on which operation video information is handled, operation video information being one of various types of data in the plant monitoring controller 2. An operation video screen window W1 and a date specifying window W2 are displayed on the screen 90, on which operation video information is handled.

The operation video screen window W1 displayed on the monitor M includes a video display area 20, a reproduction button 22, a fast forward button 23, a rewind button 24, a halt button 25, and a screen closing button 26, as seen on an ordinary moving picture player. The operation video screen window W1 also includes a date and time scroll bar 21 and a date selection button 28 as special functions. The date and time of an operation video to be displayed can be freely adjusted by moving an adjustment control 27 on the date and time scroll bar 21 to the right or left.

The reproduction button 22, fast forward button 23, rewind button 24, and halt button 25 are corresponding to a video manipulation area.

When the date selection button 28 is clicked, the date specifying window W2 is displayed on the screen. The date specifying window W2 includes a date input form 31 into which a date can be entered, a setting button 32 that displays a setting on the operation video screen window W1, and a cancel button 33 that cancels the setting and returns the observer to the operation video screen window W1. The operation video screen window W1 and date specifying window W2 may be displayed on the same screen or may be displayed on different screens.

The operation video screen window W1 in FIG. 5 can be used to call operation video information on a specified previous date from the operation video information database DB2 and display the called operation video information about the operation video screen window W1. Accordingly, a change from the called previous operation video information can be reproduced on the operation video screen window W1 on the monitor screen.

FIG. 6 illustrates computers CPU that function to create databases DB described above. The control computer CPU1 in the drawing collects process information S2 from the plant unit 1 at fixed intervals and sends the collected process information S2 to the plant history computer CPU2. The plant history computer CPU2 receives the process information S2 and stores it in the process information database DB1 in time series.

FIG. 7 extremely simply illustrates processing executed by the control computer CPU1 and plant history computer CPU2 to store the process information S2 about the plant 1 in the process information database DB1. In process step S101 in this processing, all process amounts are input at fixed intervals and are monitored. Since a vast amount of data is collected as a result of receiving a plurality of process information items at the fixed intervals, the process information is recorded only when it changes instead of recording all process information items. Specifically, whether a change is found in the process information is determined in process step S102, and only when a change is found, the process information is recorded in the process information database DB1 in process step S103.

In FIG. 7, the processing enclosed by the bold lines is executed by the plant history computer CPU2 and other processing is executed by the control computer CPU1.

Accordingly, as illustrated in FIG. 2, the process ID 101, process name 102, and process value 103 are recorded along with the date and time information 104 at the time when a change was found. In this case, these information items are recorded along with the time information five seconds later, at which “shutoff valve (A) opening” changed from 40 to 41. Therefore, the value of “shutoff valve (A) opening” at an intermediate point during this period is taken as 40 in subsequent processing in the plant monitoring controller 2.

In FIG. 6, the operation assisting computer CPU3 collects screen information 43 on the monitor M of the human-machine device 7 and stores the collected screen information 43 in the operation video information database DB2 as operation video data OV.

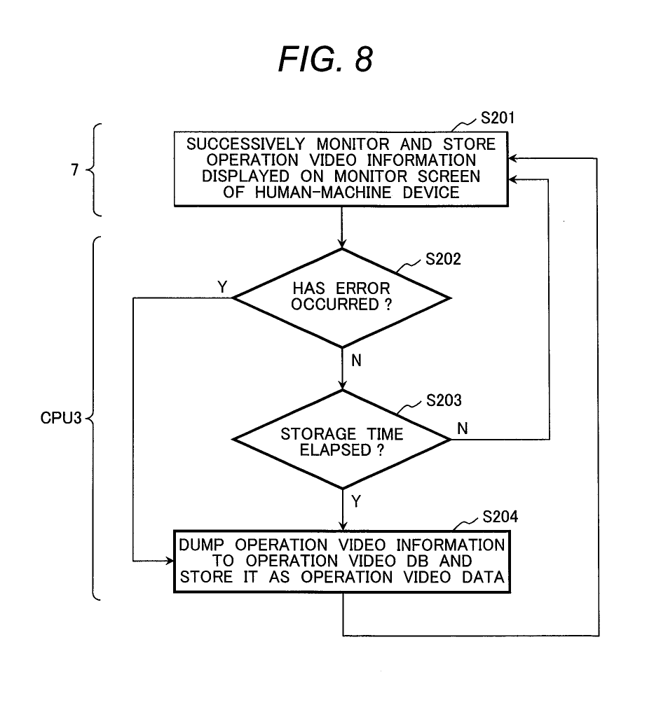

FIG. 8 illustrates processing executed by the human-machine device 7 and operation assisting computer CPU3 to store the operation video data OV in the operation video information database DB2.

In process step S201 in the drawing, operation video information displayed on the monitor screen of the human-machine device 7 is monitored and stored successively. Specifically, the operation video information is temporarily stored in, for example, a storage memory (not illustrated) used to display videos and is also displayed on the monitor M of the human-machine device 7.

Processing of the operation video information is normally awaited until a storage time elapses in process step S203, after which the operation video information is transferred to the operation video information database DB2 and is stored therein as the operation video data OV in process step S204. In the example in FIG. 3, the storage time in process step S203 is usually updated on a daily basis. If, for example, an abnormality occurs in the plant 1, however, an error is detected in process step S202 and the operation video data OV before and after the error is stored; this is advantageous in analysis and investigation in a later day.

In FIG. 8, the processing enclosed by the bold lines is executed by the operation assisting computer CPU3 and other processing is executed by the human-machine device 7.

Referring again to FIG. 6, the operation assisting computer CPU3 collects data 44 of the ID (button ID 303) of a part, manipulated by the observer, on the human-machine device 7 and “year, month, day hours:minutes:seconds” (date and time information 301) and stores the collected data 44 in the history information database DB3 as manipulation data OP.

In this example, it is assumed as a prerequisite in the accumulation of manipulation data that all pushbuttons and other parts on the human-machine device 7 have an ID. This assumption will be described with reference to FIGS. 4 and 5. For example, the monitor screen in FIG. 5 is defined as 42, which is a screen ID in FIG. 4. The manipulable devices (such as buttons) denoted 21 to 28 and 31 to 33 on the monitor screen are individually assigned a button ID in FIG. 4. This correspondence is applied to all screens displayed on the monitor M and the manipulable devices.

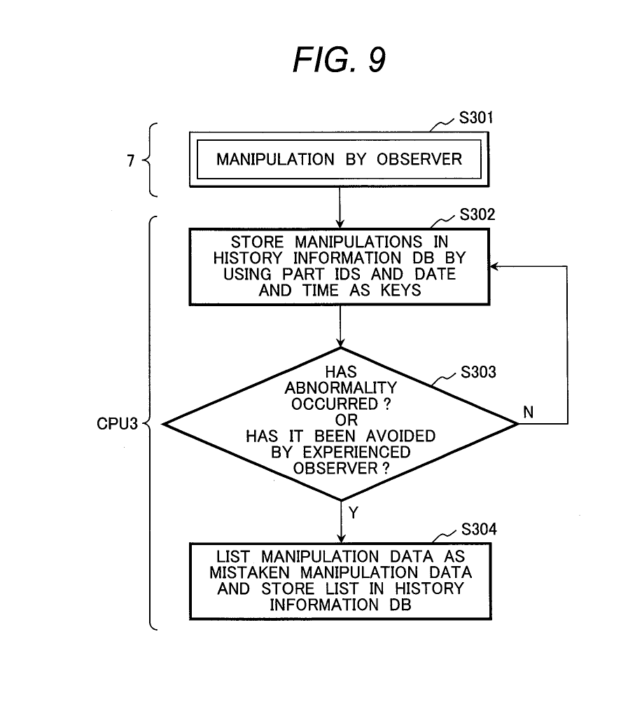

Under the above assumption, FIG. 9 extremely simply illustrates processing executed by the human-machine device 7 and operation assisting computer CPU3 to store history information in the history information database DB3.

In process step S301 in FIG. 9, the monitor M is being monitored by the observer. In process step S302, manipulations carried out by the observer are obtained and stored in the history information database DB3. FIG. 4 illustrates an example of this processing; a screen ID (302) and a button ID (303) are successively stored as paired information at each date and time (301) at which a manipulation was made.

Usually, all manipulations made on the human-machine device 7 are sent to the operation assisting computer CPU3 and are stored in the history information database DB3 as manipulation data, as described above. In process step S303, however, whether an abnormality has occurred in the plant 1 or whether an accident has been avoided by an experienced observer is determined.

If an abnormality has occurred in the plant 1 or an accident has been avoided by an experienced observer in process step S304, manipulation data is automatically listed as mistaken manipulation data until a fixed time before the occurrence of the abnormality, and the list is stored in the history information database DB3 in process step S304. As for manipulations carried out by an experienced observer to avoid accidents as well, which are not normal manipulations, the operation assisting computer CPU3 collects manipulation data in the same way as when an accident has occurred in the plant 1, lists the collected manipulation data as avoidance manipulation data, and stores the list in the history information database DB3.

Thus, in addition to manipulation histories in normal states, if an abnormality occurs, manipulation histories in a predetermined period are stored in the history information database DB3. Furthermore, manipulations carried out by an experienced observer to avoid accidents are also stored in the history information database DB3 as avoidance manipulation data.

In FIG. 9, the processing enclosed by the bold lines is executed by the operation assisting computer CPU3 and other processing is executed by the human-machine device 7.

The specific contents of the databases DB and the methods of creating the databases DB have been described. Next, auto guidance processing, which is one of the processing carried out by using data stored in the databases DB, will be described.

The auto guidance is a function that determines whether the current state of the plant 1 or its manipulation state matches a previous abnormal experience and then notifies the observer of some message. The previous abnormal experience is embodied in the mistaken manipulation data stored in process step S304 in FIG. 9, so the mistaken manipulation data is referenced.

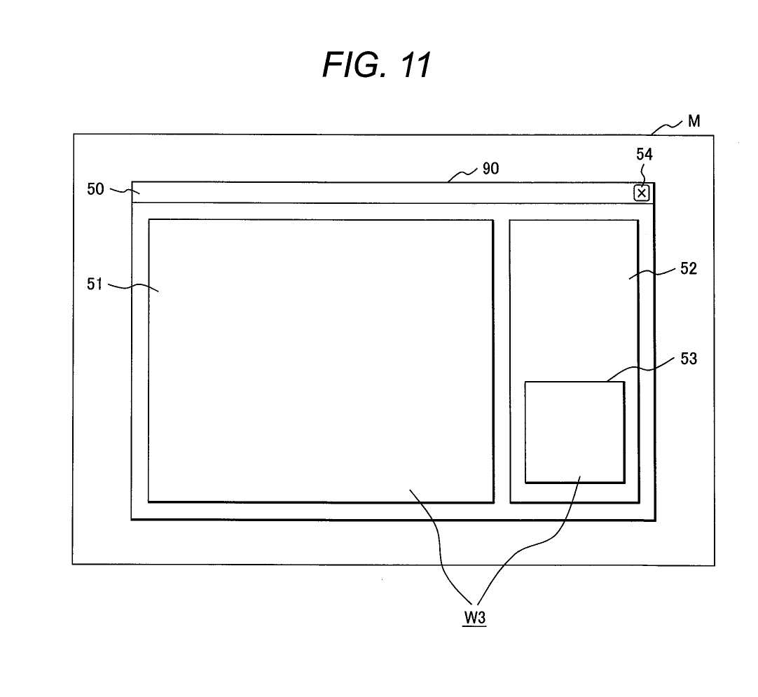

To implement this function, while the observer is manipulating the human-machine device 7, the operation assisting computer CPU3 is constantly communicating with the human-machine device 7 and makes a comparison with a previous manipulation history retrieved from the history information database DB3. If the comparison result is a complete match with a case in which an abnormality was previously found, the auto guidance message window W3 in FIG. 11 is automatically displayed on the monitor M of the human-machine device 7.

If, for example, an abnormality is experienced as a result of a series of manipulations from manipulation 1 to manipulation 10 in a previous case (mistaken manipulation data) and it is confirmed that manipulations up to manipulation 5 are the same as in the previous case, the observer is notified of an auto guidance message to indicate that the observer is proceeding toward a dangerous situation.

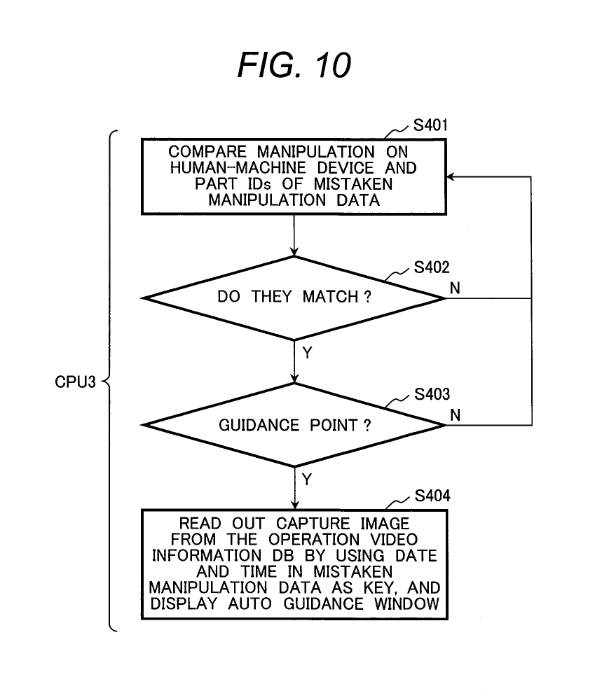

FIG. 10 illustrates processing executed by the human-machine device 7 and operation assisting computer CPU3 to implement the auto guidance message function. In the first process step S401 in FIG. 10, a manipulation on the human-machine device 7 is compared with the history information stored in the history information database DB3 in FIG. 4. Focusing particularly on the mistaken manipulation data in the history information, a comparison is made to see whether there is a button ID, in the mistaken manipulation data, that matches the ID of the last button manipulated by the observer.

In process step S402, comparisons are made until a match is found. If a match is found, it is decided in process step S403 whether a series of manipulations has proceeded to a point at which a guidance is required. In the example above, if the same manipulations as before have been executed up to manipulation 5 in the series of manipulations, it is decided that a guidance point has been reached.

In process step S404, date and time information is extracted that corresponds to the button ID obtained at the time when it was decided that a guidance point has been reached. If the button ID is, for example, the button ID 33 on the third line from the top in the DB3 in FIG. 4, the operation video information database DB2 in FIG. 3 is referenced by using the date and time information (301) corresponding to the button ID 33 as a key.

As a result, it is found that operation video information, in FIG. 3, that has time information in which the time information (301) “2011, 9, 29 10:51:10” is included is stored under a file name (203) “C:¥OPV¥2011-9-29.opv”. The operation video information is extracted and is used in an auto guidance message in a next stage.

When the process information database DB1 in FIG. 2 is similarly referenced by using the date and time information (301) as a key, a situation in which the value of the process name “shutoff valve (A) opening”, the process ID of which is V001, was changed from 40% to 41% can be obtained as the process information S2 at the date and time. This process information S2 is also extracted and is used in an auto guidance message in a next stage.

In FIG. 10, the processing enclosed by the bold lines is constantly executed by the operation assisting computer CPU3.

FIG. 11 illustrates an example of the monitor screen on which the auto guidance message described above is displayed. The auto guidance message window W3 includes a simple information display bar 50, an operation screen display area 51, a detailed message display area 52, a link 53 to an operation video screen displayed in the detailed message display area 52, and a close button 54. When the close button 54 is clicked, the auto guidance message window W3 disappears from the human-machine device 7.

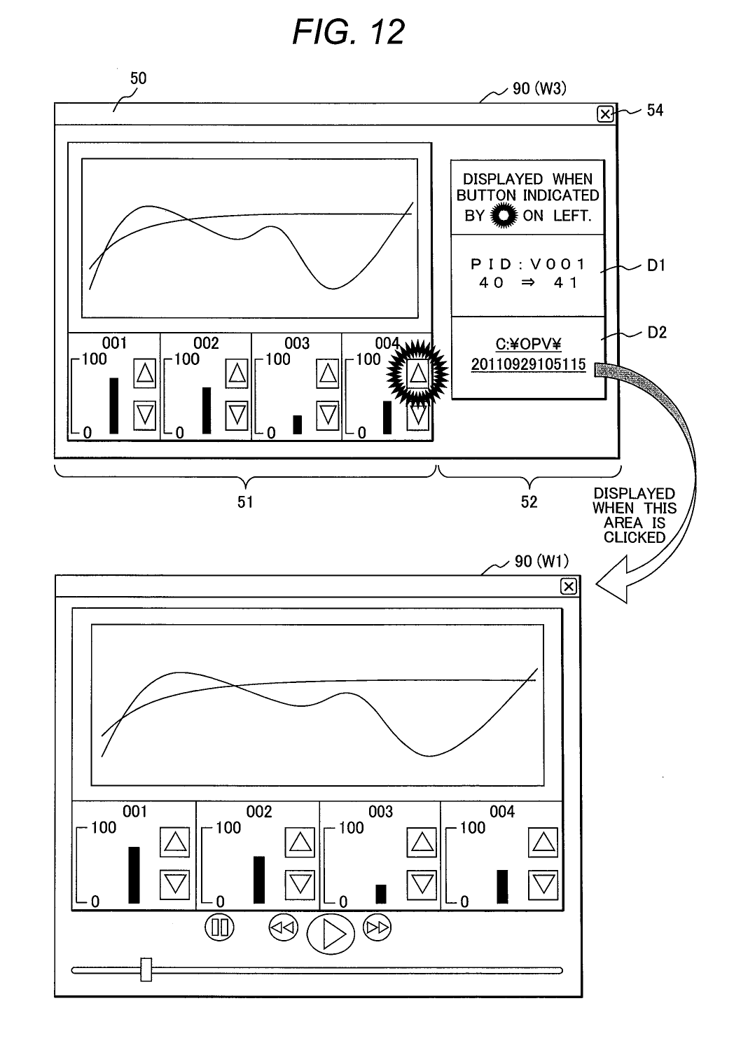

FIG. 12 illustrates a specific example of the auto guidance message window W3. In the operation screen display area 51, a screen that is currently manipulated by the observer is displayed. Amounts of various processes are displayed in the upper part, and amounts by which the observer has manipulated and manipulation signals (up and down buttons) are displayed in the lower part. In the operation screen display area 51, a detailed image is displayed showing what kind of manipulation causes an abnormality if it is performed next, out of similar manipulations in previous manipulation histories.

In the detailed message display area 52, detailed information about the screen to be displayed in the operation screen display area 51 and a link to the operation video screen are displayed as messages. For example, the area D1 links to the process information database DB1 and indicates a situation in which the value of the process information S2 (opening), the process ID of which is V001, has changed from 40% to 41%, as the process information S2 at that time. The area D2 links to the operation video information database DB2 and indicates the name of a file in which the operation video at that time is stored.

When the area D2 linking to the operation video screen is clicked, the operation video screen window W1 is called and displayed, on which the operation video screen, in FIG. 12, obtained at the time of the occurrence of a previous accident or abnormality.

Next, the mistaken manipulation setting processing, which is one of the processing carried out by using data stored in the databases described above, will be described. In the mistaken manipulation setting processing, when a previous plant manipulation is eventually found to be wrong, data that led to a mistaken manipulation is identified from data accumulated in the databases so that the data does not affect the subsequent use of other data.

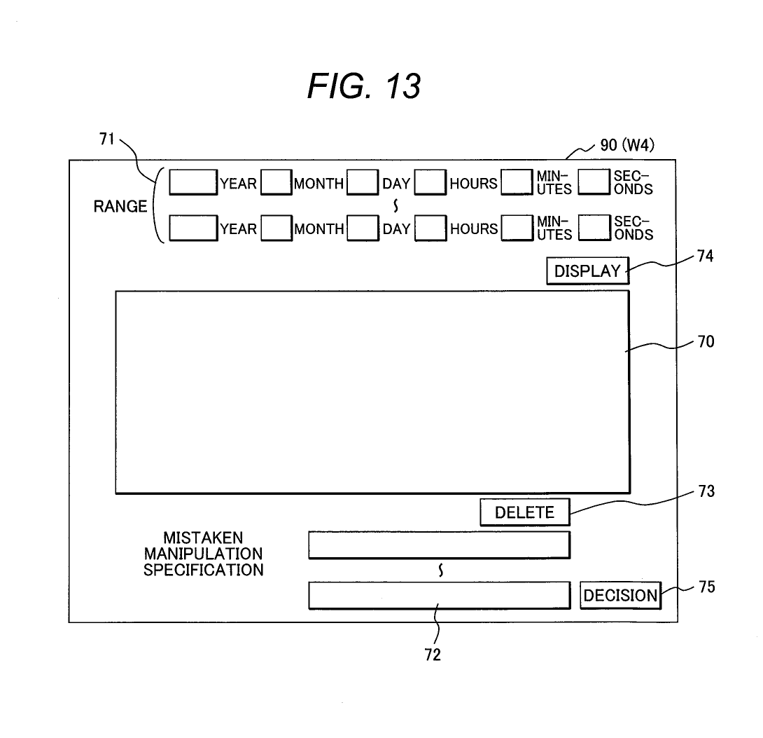

FIG. 13 illustrates the structure of a mistaken manipulation setting window W4. The mistaken manipulation setting window W4 is one of the functions called from the human-machine device 7. The mistaken manipulation setting window W4 includes a manipulation data display window 70, a date and time range specifying box 71, a mistaken operation range specifying box 72, a manipulation data deletion button 73, a display button 74, and an decision button 75.

In the manipulation data display window 70, an operation ID, the ID of a part, date and time information and the like are displayed as manipulation data of the human-machine device 7. The date and time range specifying box 71 accepts information that specifies a range of manipulation data to be displayed in the manipulation data display window 70. The mistaken operation range specifying box 72 accepts information that specifies a range of a mistaken manipulation. The manipulation data deletion button 73 deletes the manipulation data selected from the manipulation data display window 70. When the display button 74 is clicked, the manipulation data in the specified date and time range is displayed in the manipulation data display window 70. When the decision button 75 is clicked, the manipulation data in the mistaken manipulation range is stored as mistaken manipulation information.

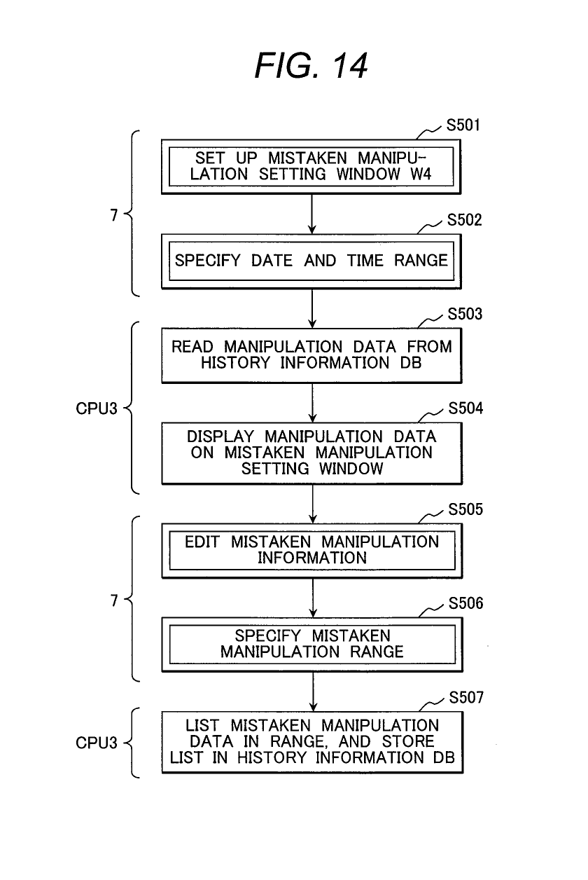

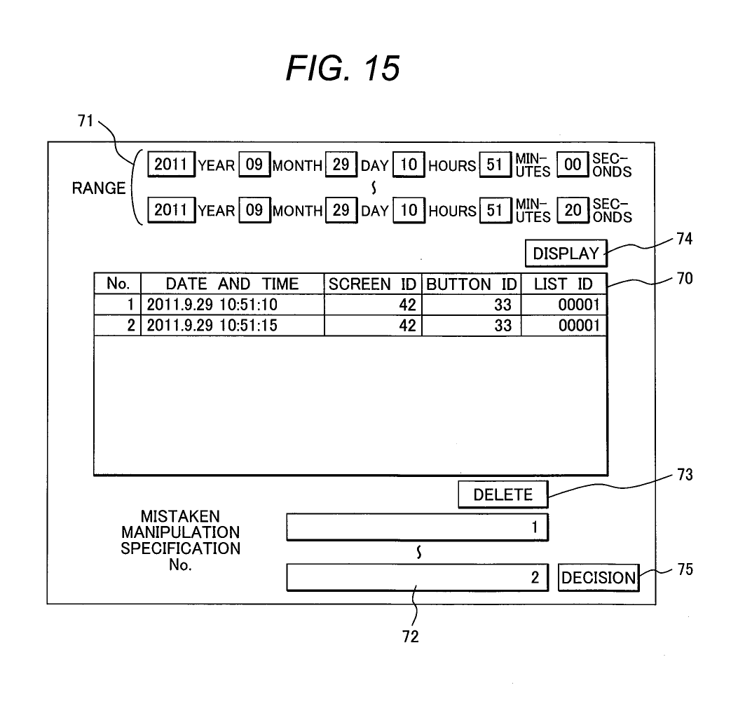

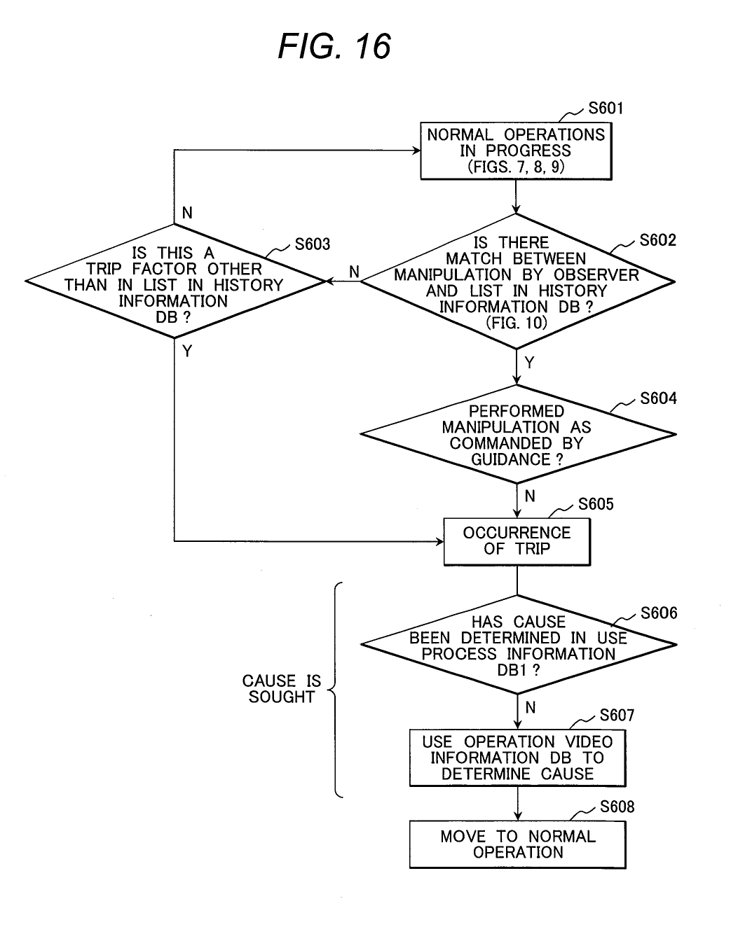

FIG. 14 illustrates functions executed by the human-machine device 7 and operation assisting computer CPU3 to implement a mistaken manipulation setting processing function. FIG. 15 illustrates a specific example of the mistaken manipulation setting window W4 on which a series of mistaken manipulation setting processing has been completed.

In the first process step S501 in FIG. 14, the observer sets up the mistaken manipulation setting window W4 on the human-machine device 7, after which the observer enters manipulation data into the date and time range specifying box 71 in the mistaken manipulation setting window W4 in process step S502. FIG. 15 indicates that 20 seconds from Sep. 29, 2011 10:51:00 to Sep. 29, 2011 10:51:20 has been specified in the date and time range specifying box 71 as a date and time range.

Next, the operation assisting computer CPU3 reads manipulation data from the history information database DB3 in process step S503 in FIG. 14 and displays the called manipulation data in the manipulation data display window 70 in the mistaken manipulation setting window W4 in process step S504. In the manipulation data display window 70 in FIG. 15, the data of the date and time (301), the screen ID (302), the button ID (303), the list ID (304) of the last two lines of the manipulation data in FIG. 4 are indicated as manipulation data. In the example in FIGS. 15, 42 and 33 are displayed as the screen ID and button ID, respectively, in the period of 20 seconds from Sep. 29, 2011 10:51:00 to Sep. 29, 2011 10:51:20

Next, mistaken manipulation information is edited in process step S505 in FIG. 14. For example, in the mistaken manipulation setting window W4, manipulations that are not directly relevant to an abnormality are deleted by the manipulation data deletion button 73, and a range of a mistaken manipulation is specified in the mistaken operation range specifying box 72 in process step S505.

In process step S507, the operation assisting computer CPU3 lists mistaken manipulation data in a period specified in the mistaken operation range specifying box 72 and stores the list in the history information database DB3. Thus, the manipulation data in this period is handled as mistaken manipulation data in subsequent processing and is differentiated from other manipulation data at normal times or abnormal times.

In FIG. 14, processing enclosed by double lines is executed by the human-machine device 7 and other processing is executed by the operation assisting computer CPU3.

Finally, the position of the present invention in an entire flow in a normal operation, at the occurrence of a trip, and in the clarification of the cause of the trip will be described with reference to FIG. 16.

In process step S601 in FIG. 16, a normal operation is being carried out in the plant 1. At this stage, input processing to the databases DB is being continuously executed and the computers CPU and human-machine device 7 are executing the processing in FIGS. 7, 8, and 9 in cooperation.

Particularly, in process step S602, the processing in FIG. 10 is executed to see whether the last manipulation carried out by the observer matches a previous manipulation example in the history information database DB3. In process step S603, if there is no matching previous manipulation example, a series of monitoring processing is continuously repeated.

In process step S604, if there is a matching previous manipulation example, guidance processing is executed.

An abnormality occurred in the plant 1 while this state was continuing. In process step S605, the plant 1 was tripped.

After the plant 1 was tripped, the cause to the trip is sought. In this case, since the date and time at which the plant 1 was tripped is clear, data before the trip is used to start the seeking of the cause of the trip. In normal processing, process information stored in the process information database DB1 is referenced as the data before the trip in process step S606.

Furthermore, in the present invention, operation video information recorded in the operation video information database DB2 is referenced in process step S607. History information recorded in the history information database DB3 is also referenced. A link between these information items can be used to, for example, check correspondence referenced in the date and time information.

If the cause of the trip is determined in process step S607, a restoration manipulation is performed, after which the plant 1 moves to a normal operation in process step S608.

According to the plant monitoring controller, described above, in the present invention, a plant monitoring controller that is improved in the identification of the cause of an abnormality can be provided. The plant monitoring controller in the present invention has an operation video function that accumulates video information, which is screens themselves, as history information, besides plant history information, and also has an auto operation guidance function that links process information and operation video information together, accumulates the linked information as guidance information, and automatically performs a guidance. Therefore, advantageous effects are obtained as described below.

First, specific conventional practice is such that when a skilled observer performs a pre-manipulation to avoid an accident, the manipulation is not analyzed because no accident has occurred. In the present invention, however, a manipulation to avoid an accident is also recorded in a history as illustrated in FIG. 9; when recorded as operation video information, the manipulation can be used.

A second effect is concerned with a mistaken manipulation caused by an observer, which is an example of a case in which a direct cause is that process information does not change. In the present invention, however, a previous mistaken manipulation caused by an observer is recorded as operation video information, so it can be used in the future.

As a third effect, the problem that the cause of the abnormality can be displayed only in a predetermined format has been solved. In the present invention, a previous manipulation example that has led to an accident as a result of the same manipulation as the current manipulation is extracted from the operation video information, so a guidance that matches the actual state is possible.

As a fourth effect, the problem that although process information can be restored, the restored process information has to be used to select a screen that is viewed to identify the cause of the abnormality has been solved. In the present invention, a screen of a previous manipulation example is directly displayed.

As described above, the plant monitoring controller in the present invention has a mechanism that handles the state of a plant as process information and accumulates the process information, an operation video function that reproduces a screen manipulated by an observer on a human-machine device without alteration, and an auto operation guidance function that uses difference information about plant manipulations and operation video information and records a history at the occurrence of an abnormality as an image and a message so that when a similar operation is carried out, the image and message are automatically displayed on the human-machine device as a guidance window.

1. A plant monitoring controller, provided with a monitor, that obtains process information from a plant and provides an operation signal to the plant, characterized in that;
the plant monitoring controller comprising:
a process information database in which process information about the plant is recorded and accumulated;
an operation video information database in which operation video information, which is video information displayed on a screen on the monitor, is recorded and accumulated as history information; and
a history information database in which manipulation histories of the manipulable devices displayed on a screen on the monitor are accumulated as manipulation history information;
wherein manipulable devices are displayed by being distinguished with each other on a screen given on the monitor;
the process information, the operation video information, and the manipulation history information are recorded along with time information; and
an operation video screen is provided as a screen displayed on the monitor, the operation video screen displaying a change from previous operation video information, read from the operation video information database, along with the time information.

2. The plant monitoring controller according to claim 1, wherein a manipulation state of a manipulable device on the screen displayed on the monitor is compared with previous manipulation histories recorded in the history information database, and if there is a matching manipulation history and the matching manipulation history indicates a problem caused in the past, the operation video screen is called and displayed.

3. The plant monitoring controller according to claim 2, wherein in correspondence to the operation video screen which has been called and displayed to indicate information at a previous time, information about the previous time is displayed.

4. The plant monitoring controller according to claim 1, wherein:
the operation video screen includes a video display area, a video manipulation area, a time scroll bar, and a date and time selection area; and
a change between observer manipulation screens in a specified period is displayed.
